(19) United States
(12) Patent Application Publication
(10) Pub. No.: US 2018/0201784 A1
(43) Pub. Date: Jul. 19, 2018

(54) SOLVENT COMPOSITION COMPRISING A MIXTURE OF A MOLECULE HAVING A SULPHOXIDE FUNCTION AND A MOLECULE HAVING AN AMIDE FUNCTION

(71) Applicant: Arkema France, Colombes (FR)

(72) Inventor: Paul Guillaume SCHMITT, Lescar (FR)

(73) Assignee: Arkema France, Colombes (FR)

(21) Appl. No.: 15/757,990

(22) PCT Filed: Sep. 15, 2016
(86) PCT No.: PCT/FR2016/052337

§ 371 Date: Mar. 7, 2018

(30) Foreign Application Priority Data
Sep. 15, 2015 (FR) 1558600

(51) Int. Cl. C08L 75/04; C08L 81/06; C08J 3/09; C08J 3/11; B01D 71/68; B01D 67/00; B01D 69/08

(52) U.S. Cl. CPC C08L 75/04; C08J 2481/06; C08J 3/097; C08J 3/096; C08J 3/11; B01D 71/68; B01D 67/0011; B01D 69/08; C08L 2201/08; C08L 2203/12; C08L 2203/16; C08L 2205/025; C08J 2381/06; C08J 2375/04; C08L 81/06

(57) ABSTRACT

The invention relates to a solvent composition containing a mixture of at least one molecule having at least one sulphoxide function and at least one molecule having at least one amide function wherein the nitrogen atom supports a hydrogen atom. The invention also relates to the use of the solvent composition in order to stabilise polymer solutions. The invention also relates to a polymer solution containing the solvent composition and to a filtering membrane and an artificial leather obtained from the polymer solution.

### FIELD OF THE INVENTION

The invention relates to a solvent composition and to its use in stabilizing polymeric solutions, it being possible for said polymeric solutions to be used in particular in the manufacture of films, membranes, artificial leather, polymeric suede, polymeric fibers, coatings, electronic circuits or batteries, in particular lithium-ion (Li-ion) batteries, or in the protection of electric cables by sheathing. The invention also relates to a polymer solution and to a filtration membrane obtained from the polymer solution.

### TECHNICAL BACKGROUND

Polymeric films or hollow polymer fibers can be used in various applications, such as the coating of textiles, in particular artificial leather, suede for shoes or individual protective equipment; batteries, in particular Li-ion batteries; membranes, in particular for the treatment of water or dialysis; sheathings for the protection of electric cables; or electronic circuits.

Mention may be made, among the polymers which can be used in these applications, of polyurethanes (PU), polysulfones (PSU), polyvinylidene fluorides (PVDF), polyethersulfones (PES), polyphenylsulfones (PPSU) cellulose acetate, polyamide-imides (PAI) or polyimides (PI), this list not being limiting.

The processes for the manufacture of these polymer films or fibers comprise many stages, among which may be mentioned:
synthesis of the polymer in a solvent medium,
dissolution of the polymer in a solvent, in the case where the polymer resulting from the synthesis is introduced in the solid form (for example in the extruded form or in the form of beads), in order to obtain a polymeric solution,
production of a film by a process of coating with the polymeric solution, followed by drying (heat treatment: dry process) in order to evaporate the solvent,

it also being possible for this stage to be replaced by a stage of:
production of a film or of a hollow fiber by a process of impregnation on a support of the polymeric solution or of spinning the polymeric solution, followed by dipping in a third solvent (for example water), making it possible to precipitate the polymer and to cause the solvent to migrate from the polymeric solution toward the third solvent (coagulation: wet process).

The process can additionally comprise:
optionally recycling the solvent,
optionally sending the aqueous solutions generated to waste water treatment plants.

Currently, the solvents commonly used for the manufacture of these polymer films or hollow polymer fibers are polar aprotic solvents, such as NMP (N-methylpyrrolidone), DMF (dimethylformamide) and DMAc (dimethylacetamide). Nevertheless, these solvents exhibit many toxicological disadvantages as they are categorized as CMR (carcinogenic, mutagenic and reprotoxic) and toxic.

It is thus advantageous to replace these solvents by solvents exhibiting a better toxicological profile.

Alternatives to these toxic solvents have been provided.

The document WO 2005/090447 provides for the replacement of NMP by N-ethyl-2-pyrrolidone (NEP). However, NEP is categorized as reprotoxic by the European Union.

In the document WO 2008/012231, provision is made to replace NMP by 1,5-dimethylpyrrolidone (DMP). Reprotoxicity studies have shown that DMP is suspected of being reprotoxic in the same way as NMP.

More recently, the document WO 2013/107822 provides for the partial or complete replacement of the toxic solvents, such as NMP, DMF or DMACs, by a solvent chosen from N-butylpyrrolidone, N-isobutylpyrrolidone, N-(t-butyl)pyrrolidone, N-(n-pentyl)pyrrolidone, N-((methyl-substituted)butyl)pyrrolidone, N-propyl- or N-butylpyrrolidone, the ring of which is methyl-substituted, or N-(methoxypropyl)pyrrolidone.

Provision has also been made to use dimethyl sulfoxide (DMSO) as solvent for the manufacture of polymer films or hollow polymer fibers.

The use of DMSO and of 2-pyrrolidone alone presents problems of stability of the polymeric solutions, which renders an industrial process very difficult, indeed even impossible, to carry out without significant adaptation of the process. DMSO or 2-pyrrolidone makes it possible to dissolve the polymers, such as polyurethanes or polysulfones, by heating these solutions at approximately 50° C. for several hours, but the polymeric solutions obtained rapidly gel, indeed even solidify, after returning to working temperatures of the order of 0 to 20° C.

There currently do not exist solvent compositions, not categorized as CMR, which make it possible both to dissolve the polymers and to obtain polymeric solutions which are stable, in particular at low temperature (temperature of the order of 0° C., for example), over a period which can range from a few days up to several weeks (for example 3 weeks). This is because, in order to obtain an industrial solution, it is necessary for the polymeric solutions to be stable and not to gel for a few hours, indeed even a few weeks, thus making it possible to overcome the uncertainties of industrial production (unit shutdown, problem of heating the plants, and the like) and the problem of storage, this being at temperatures which can reach 0° C., for example.

The document JP1266811 provides a membrane having hollow fibers which is obtained by mixing a polyethersulfone, DMSO, 2-pyrrolidone and a polyethylene glycol with an average molecular weight of 200 (PEG 200). This document teaches that 2-pyrrolidone makes it possible to increase the permeability of the membrane having hollow fibers and also the mechanical strength. 2-Pyrrolidone, just like PolyEthylene Glycol (PEG) or PolyVinylPyrrolidone (PVP), is thus used to improve the permeation of the membrane. It is known that the addition of porogenic agents makes it possible to modify the structure of the pores of the membranes and thus the permeation. Mention may be made, for example, of the paper Desalination, 207 (2007), 324-339, “Synthesis, characterization and performance of asymmetric polyethersulfone (PES) ultrafiltration membranes with polyethylene glycol of different molecular weights as additives”, and also of the paper Physics and Chemistry of the Earth, 67-69 (2014), 125-131, “Preparation of antifouling polyvinylpyrrolidone modified polyethersulfone ultrafiltration membrane for water purification”. The document JP1266811 does not in any way mention the problem of the stability of the polymeric solutions and it does not describe the solvent composition according to the present invention.

### SUMMARY OF THE INVENTION

The invention relates first to a solvent composition comprising a mixture of at least one molecule having at least one sulfoxide functional group and of at least one molecule having at least one amide functional group where the nitrogen atom carries a hydrogen atom (—NH—C(O)—), said composition being substantially devoid of polyethersulfones. The term “substantially devoid of polyethersulfones” is understood to mean that said composition can contain one or more polyethersulfones in an amount of less than 1% by weight, preferably of less than 0.5% by weight, with respect to the total weight of the composition.

According to a specific embodiment, the solvent composition according to the invention is substantially devoid of polymers. The term “substantially devoid of polymers” is understood to mean that said solvent composition can contain one or more polymers in an amount of less than 1% by weight, preferably of less than 0.5% by weight, with respect to the total weight of the composition.

According to a preferred embodiment, the molecule carrying the amide functional group is cyclic. Preferably, the molecule carrying an amide functional group is 2-pyrrolidone. Preferably, the molecule carrying an amide functional group is not ε-caprolactam.

According to a preferred embodiment, the molecule carrying a sulfoxide functional group is dimethyl sulfoxide.

According to one embodiment, the solvent composition according to the invention comprises dimethyl sulfoxide and 2-pyrrolidone.

According to one embodiment, the solvent composition according to the invention comprises:
from 21% to 75% by weight, preferably from 25% to 70% by weight, more preferably from 30% to 65% by weight, of the molecule carrying a sulfoxide functional group,
from 25% to 80% by weight, preferably from 30% to 75% by weight, more preferably from 35% to 70% by weight, of the molecule carrying an amide functional group where the nitrogen atom carries a hydrogen atom,

with respect to the total weight of the composition.

According to one embodiment, the composition according to the invention additionally comprises at least one other cosolvent preferably chosen from water, ketones, amines, alcohols, ethers, esters, sulfones, aromatic compounds or acetals or from N-butylpyrrolidone, N-isobutylpyrrolidone, N-(t-butyl)pyrrolidone, N-(n-pentyl)pyrrolidone, N-((methyl-substituted) butyl)pyrrolidone, N-propyl- or N-butylpyrrolidone, the ring of which is methyl-substituted, or N-(methoxypropyl)pyrrolidone, dipropylene glycol dimethyl ether (DPGDME), polyglyme, ethyl diglyme, 1,3-dioxolane or methyl 5-(dimethylamino)-2-methyl-5-oxopentanoate.

The invention also relates to the use of the solvent composition according to the invention for improving the stability of solutions of polymers.

Preferably, the solutions of polymers are solutions of polymers having sulfone or urethane functional groups.

Preferably, the polymer solution is a polysulfone or polyethersulfone or polyphenylsulfone solution, preferably a polysulfone solution.

The invention also relates to a polymer solution, said solution comprising a solvent composition comprising a mixture of at least one molecule having at least one sulfoxide functional group and of at least one molecule having at least one amide functional group where the nitrogen atom carries a hydrogen atom (—NH—C(O)—), said polymer solution being substantially devoid of polyethersulfones. The term “substantially devoid of polyethersulfones” is understood to mean that said polymer solution can contain one or more polyethersulfones in an amount of less than 1% by weight, preferably of less than 0.5% by weight, with respect to the total weight of said solution.

Preferably, the polymer of the polymer solution exhibits sulfone or urethane functional groups.

According to a preferred embodiment, the polymer solution comprises a solvent composition as defined in the present invention.

According to one embodiment, the polymer solution comprises:
from 5% to 50% by weight, preferably from 8% to 35% by weight, of polymers, and
from 50% to 95% by weight, preferably from 65% to 92% by weight, of the solvent composition,

with respect to the total weight of the polymer solution.

Another subject matter of the invention is a filtration membrane obtained from the polymer solution according to the invention.

The invention also relates to an artificial leather obtained from the polymer solution according to the invention.

Another subject matter of the invention is the use of the polymer solution according to the invention for the manufacture of films, artificial leather, polymeric suede, polymeric fibers, coatings, membranes, batteries or electronic circuits or for the protection of electric cables.

The solvent composition according to the present invention makes it possible to stabilize polymeric solutions and to do so over a wide temperature range, in particular at low temperatures. The present invention makes it possible to provide a unique solvent composition exhibiting a universal nature which makes it possible to stabilize highly varied polymers, namely equally well polyurethanes, polyethersulfones and polysulfones.

The polymeric solutions according to the present invention are stable, at ambient temperature and/or at low temperature, and over a period ranging up to several weeks.

The solvent(s) used are not or only slightly toxic. In particular, the solvent(s) used are not categorized as CMR.

### DESCRIPTION OF EMBODIMENTS OF THE INVENTION

The invention is now described in greater detail and in a nonlimiting manner in the description which follows.

The present invention provides a solvent composition comprising a mixture of at least one molecule having at least one sulfoxide functional group and of at least one molecule having at least one amide functional group where the nitrogen atom carries a hydrogen atom (—NH—C(O)—), said composition being substantially devoid of polyethersulfones, preferably completely devoid of polyethersulfones. The two molecules (that carrying the sulfoxide functional group and that carrying the amide functional group) are separate from one another.

The molecule carrying the sulfoxide functional group can, for example, comprise from 2 to 24 carbon atoms, preferably from 2 to 12 carbon atoms, more preferably from 2 to 6 carbon atoms.

The molecule carrying the amide functional group can, for example, comprise from 2 to 24 carbon atoms, preferably from 2 to 12 carbon atoms, more preferably from 2 to 6 carbon atoms, more preferably from 2 to 5 carbon atoms, entirely preferably 2, 3 or 4 carbon atoms.

Preferably, the molecule or molecules exhibiting at least one sulfoxide functional group exhibit just one sulfoxide functional group.

Preferably, the molecule or molecules exhibiting at least one amide functional group exhibit just one amide functional group.

According to one embodiment of the invention, the solvent composition consists essentially and preferably exclusively of molecules carrying a sulfoxide functional group and molecules carrying an amide functional group where the nitrogen atom carries a hydrogen atom (—NH—C(O)—).

According to one embodiment, the solvent composition according to the invention is substantially devoid of polymers, preferably completely devoid of polymers, in particular of polymers of polyethersulfone type.

The term “polymers” within the meaning of the present invention is understood to mean all molecules exhibiting at least two identical units (monomers) connected via a covalent bond. The polymer according to the present invention can be of natural or synthetic origin, being able to be obtained by polymerization, polycondensation or polyaddition.

Preferably, the molecule having at least one amide functional group is cyclic; in particular, the amide functional group is a cyclic amide functional group. More preferably, the molecule having at least one amide functional group is 2-pyrrolidone.

Preferably, the molecule carrying a sulfoxide functional group is dimethyl sulfoxide (DMSO).

According to a specific embodiment, the solvent composition comprises DMSO and 2-pyrrolidone. According to one embodiment, the solvent composition according to the invention consists essentially and preferably exclusively of DMSO and 2-pyrrolidone.

Preferably, the solvent composition according to the invention comprises:
from 21% to 75% by weight, preferably from 25% to 70% by weight, more preferably from 30% to 65% by weight, of molecule(s) carrying a sulfoxide functional group,
from 25% to 79% by weight, preferably from 30% to 75% by weight, more preferably from 35% to 70% by weight, of molecule(s) carrying an amide functional group where the nitrogen atom carries a hydrogen atom,

with respect to the total weight of the solvent composition.

According to one embodiment, the solvent composition consists essentially and preferably exclusively of:
from 21% to 75% by weight, preferably from 25% to 70% by weight, more preferably from 30% to 65% by weight, of molecule(s) carrying a sulfoxide functional group,
from 25% to 79% by weight, preferably from 30% to 75% by weight, more preferably from 35% to 70% by weight, of molecule(s) carrying an amide functional group where the nitrogen atom carries a hydrogen atom,

with respect to the total weight of the solvent composition.

According to one embodiment, the ratio by weight of the molecule(s) carrying at least one sulfoxide functional group to the molecule(s) carrying at least one amide functional group ranges from 90/10 to 10/90, preferably from 80/20 to 20/80, more preferably from 70/30 to 30/70, more preferentially from 60/40 to 40/60.

According to one embodiment, the solvent composition comprises approximately 50% by weight of DMSO and approximately 50% by weight of 2-pyrrolidone, with respect to the total weight of the solvent composition.

According to one embodiment, the solvent composition additionally comprises at least one other solvent, different from the two molecules described above. Mention may be made, without limitation, as examples of other solvents, of:
water;
ketones, such as acetone, methyl ethyl ketone (MEK), methyl isobutyl ketone, hexanone, cyclohexanone, ethylamine ketone, isophorone, trimethylcyclohexanone, γ-butyrolactone or diacetone alcohol;
amines, such as monoethanolamine (MEoA), diethanolamine (DEoA), propanolamine (PoA), butylisopropanolamine (BiPoA), isopropanolamine (iPoA), 2-[2-(3-aminopropoxy)ethoxy]ethanol, N-(2-hydroxyethyl)diethylenetriamine, (3-methoxy)propylamine (MoPA), 3-isopropoxypropylamine (IPOPA), monoethylamine, diethylamine, diethylaminopropylamine (DEAPA), triethylamine (TEA) or acetonitrile;
alcohols, such as ethanol, methanol, propanol, isopropanol, glycerol, diacetone alcohol, butanol, methyl isobutyl carbinol, hexylene glycol or benzyl alcohol;
ethers, such as tetrahydrofuran (THF), methylfuran, methyltetrahydrofuran, tetrahydropyran or glycol dialkyl ether;
esters, such as dibasic esters, dimethyl glutarate, dimethyl succinate, dimethyl adipate, butyl acetate, ethyl acetate, diethyl carbonate, dimethyl carbonate, propylene carbonate, ethyl methyl carbonate, glycerol carbonate, dimethyl 2-methylglutarate, dimethyl 2-methyladipate, dimethyl 2-methylsuccinate, n-butyl propionate, benzyl acetate or ethyl ethoxypropionate;
sulfones, such as dimethyl sulfone or sulfolane;
aromatic compounds, such as toluene or xylene;
acetals, such as methylal, ethylal, butylal, dioxolane or TOU (tetraoxaundecane);
glycol ethers of E or P type, such as dipropylene glycol dimethyl ether (DPGDME) or dipropylene glycol methyl ether.

Mention may also be made, as examples of other solvent, of the following solvents: N-butylpyrrolidone, N-isobutylpyrrolidone, N-(t-butyl)pyrrolidone, N-(n-pentyl)pyrrolidone, N-((methyl-substituted)butyl)pyrrolidone, N-propyl- or N-butylpyrrolidone, the ring of which is methyl-substituted, or N-(methoxypropyl)pyrrolidone, polyglyme, ethyl diglyme, 1,3-dioxolane or methyl 5-(dimethylamino)-2-methyl-5-oxopentanoate.

According to one embodiment, the solvent composition additionally comprises at least one porogenic agent, such as a PEG or PVP.

The present invention also provides for the use of the solvent composition according to the invention for improving the stability of polymer solutions.

Polymer solutions or polymeric solutions are obtained by dissolution or dispersion of polymers in the solvent composition according to the invention.

The polymeric solutions or polymer solutions can be chosen from polyurethane solutions, polysulfone solutions, polyphenylsulfone solutions, polyethersulfone solutions, polyvinylidene fluoride (PVDF) solutions, cellulose acetate, polyamide-imides (PAI) or polyimides (PI).

Preferably, the polymer solutions are solutions of polymers having sulfone or urethane functional groups. Preferably, the polymer solutions are chosen from polyurethane solutions, polyphenylsulfone solutions, polyethersulfone solutions and polysulfone solutions, more preferably from polysulfone and polyurethane solutions, in particular from polysulfone solutions.

The term “polysulfone” is understood to mean, within the meaning of the present invention, a polymer exhibiting at least two units (n≥2) of formula:

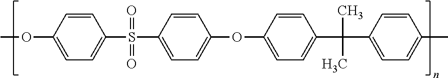

The term “polyethersulfone” is understood to mean, within the meaning of the present invention, a polymer exhibiting at least two units (n≥2) of formula:

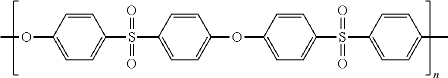

The term “polyphenylsulfone” is understood to mean, within the meaning of the present invention, a polymer exhibiting at least two units (n≥2) of formula:

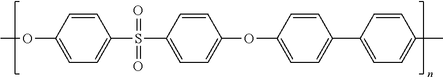

Within the meaning of the present invention, a polyethersulfone is not a polysulfone.

The solvent compositions according to the present invention effectively make it possible to improve the stability of the polymeric solutions at ambient temperature (temperature ranging from 20° C. to 30° C., preferably approximately 25° C.) or at low temperature (temperature ranging from −10° C. to +10° C., preferably approximately 0° C.); preferably, the stability is improved both at ambient temperature and at low temperature.

The solvent compositions according to the present invention make it possible to improve the stability on storage of the polymeric solutions, in particular for a storage time which can vary from a few hours to several weeks.

The improvement in the stability of the solutions can be characterized by the production of a liquid solution, unlike a solid or a gel. The improvement can also be characterized by a transparent or very slightly colored appearance, unlike a cloudy appearance. The improvement in the stability can be evaluated immediately after preparation of the solutions or else after a prolonged period of time, for example ranging from 1 day to 3 weeks.

The present invention also provides a polymer solution, said solution comprising a solvent composition comprising a mixture of at least one molecule exhibiting at least one sulfoxide functional group and of at least one molecule exhibiting at least one amide functional group where the nitrogen atom carries a hydrogen atom (—NH—C(O)—), said solution being substantially devoid of polyethersulfones. The two molecules (that carrying the sulfoxide functional group and that carrying the amide functional group) are separate from one another.

Preferably, the polymer solution according to the invention is completely devoid of polyethersulfones.

Preferably, the polymer solution according to the invention is a solution of polymer having sulfone or urethane functional groups, it being understood that said solution is substantially, in particular completely, devoid of polyethersulfones.

The polymer solution according to the invention can comprise a polysulfone and/or a polyurethane and/or a polyphenylsulfone.

According to a preferred embodiment, the polymer solution according to the invention is a polysulfone solution.

According to one embodiment of the invention, the solvent composition of the polymer solution according to invention consists essentially of molecules carrying a sulfoxide functional group and molecules carrying an amide functional group where the nitrogen atom carries a hydrogen atom (—NH—C(O)—).

Preferably, the molecule carrying an amide functional group is cyclic; in particular, the amide functional group can be a cyclic amide functional group. More preferably, the molecule carrying the amide functional group is 2-pyrrolidone.

Preferably, the molecule carrying a sulfoxide functional group is dimethyl sulfoxide (DMSO).

According to a specific embodiment, the solvent composition of the polymer solution comprises DMSO and 2-pyrrolidone. According to one embodiment, the solvent composition of the polymer solution according to the invention consists essentially and preferably exclusively of DMSO and 2-pyrrolidone.

According to one embodiment, the solvent composition of the polymer solution comprises:
from 21% to 75% by weight, preferably from 25% to 70% by weight, more preferably from 30% to 65% by weight, of the molecule carrying a sulfoxide functional group,
from 25% to 79% by weight, preferably from 30% to 75% by weight, more preferably from 35% to 70% by weight, of the molecule carrying an amide functional group where the nitrogen atom carries a hydrogen atom,

with respect to the total weight of the solvent composition.

According to one embodiment, the solvent composition of the polymer solution consists essentially and preferably exclusively of:
from 21% to 75% by weight, preferably from 25% to 70% by weight, more preferably from 30% to 65% by weight, of the molecule carrying a sulfoxide functional group,
from 25% to 79% by weight, preferably from 30% to 75% by weight, more preferably from 35% to 70% by weight, of the molecule carrying an amide functional group where the nitrogen atom carries a hydrogen atom,

with respect to the total weight of the solvent composition.

According to one embodiment of the invention, the polymer solution comprises:
from 5% to 50% by weight, preferably from 8% to 35% by weight, of polymers, and
from 50% to 95% by weight, preferably from 65% to 92% by weight, of the solvent composition,

with respect to the total weight of the solution.

According to one embodiment of the invention, the polymer solution consists essentially of:
from 5% to 50% by weight, preferably from 8% to 35% by weight, of polymers, and
from 50% to 95% by weight, preferably from 65% to 92% by weight, of the solvent composition,

with respect to the total weight of the solution.

According to one embodiment of the invention, the polysulfone solution comprises:
from 5% to 50% by weight, preferably from 8% to 35% by weight, of polysulfone, and
from 50% to 95% by weight, preferably from 65% to 92% by weight, of the solvent composition,

with respect to the total weight of the solution.

According to one embodiment of the invention, the polysulfone solution consists essentially of:
from 5% to 50% by weight, preferably from 8% to 35% by weight, of polysulfone, and
from 50% to 95% by weight, preferably from 65% to 92% by weight, of the solvent composition,

with respect to the total weight of the solution.

According to one embodiment of the invention, the polyurethane solution comprises:
from 5% to 50% by weight, preferably from 8% to 35% by weight, of polyurethane, and
from 50% to 95% by weight, preferably from 65% to 92% by weight, of the solvent composition,

with respect to the total weight of the solution.

According to one embodiment of the invention, the polyurethane solution consists essentially of:
from 5% to 50% by weight, preferably from 8% to 35% by weight, of polyurethane, and
from 50% to 95% by weight, preferably from 65% to 92% by weight, of the solvent composition,

with respect to the total weight of the solution.

The invention also relates to a filtration membrane obtained from the polymer solution according to the invention.

Preferably, the filtration membrane is a membrane having hollow fibers which can be used nonlimitingly for the treatment of water or for dialyses.

Preferably, the membrane according to the invention is obtained from the polysulfone solution according to the invention.

The filtration membrane according to the invention can be obtained according to a process well known to a person skilled in the art.

According to one embodiment of the invention, the filtration membrane is obtained by a process comprising:
provision of a polymer, preferably a polysulfone,
dissolution of the polymer in the solvent composition according to the invention comprising a mixture of at least one molecule having a sulfoxide functional group and of at least one molecule having at least one amide functional group where the nitrogen atom carries a hydrogen atom (—NH—C(O)—), in order to obtain the polymer solution, preferably the polysulfone solution, according to the invention,
production of a hollow fiber by a process of spinning the polymeric solution, followed by dipping in a third solvent (for example water), making it possible to precipitate the polymer and to cause the solvent to migrate from the polymeric solution toward the third solvent (coagulation: wet process).
optionally recycling the solvent,
optionally sending the aqueous solutions generated to waste water treatment plants.

The invention also relates to an artificial leather obtained from the polymer solution according to the invention.

Preferably, the artificial leather is obtained from the polyurethane solution according to the invention.

The artificial leather according to the invention can be obtained according to a process well known to a person skilled in the art.

According to one embodiment of the invention, the artificial leather is obtained by a process comprising:
synthesis of the polymer, preferably a polyurethane, in a solvent medium, in order to obtain a polymer in the solid form or in the resin form containing the polymer and solvent,
dissolution of the polymer in the solid or resin form in the solvent composition according to the invention comprising a mixture of at least one molecule having a sulfoxide functional group and of a molecule having at least one amide functional group where the nitrogen atom carries a hydrogen atom (—NH—C(O)—), in order to obtain the polymer solution, preferably the polyurethane solution, according to the invention,
production of a film by a process of coating with the polymeric solution, followed by drying (heat treatment: dry process) in order to evaporate the solvent,

it also being possible for this stage to be replaced by a stage of:
production of a film by a process of impregnation on a support of the polymeric solution, followed by dipping in a third solvent (for example water), making it possible to precipitate the polymer and to cause the solvent to migrate from the polymeric solution toward the third solvent (coagulation: wet process),
optionally recycling the solvent,
optionally sending the aqueous solutions generated to waste water treatment plants.

Another subject matter of the invention is the use of the polymer solution according to the invention for the manufacture of articles such as films, artificial leather, polymeric suede, polymeric fibers, coatings, membranes, batteries or electronic circuits or for the protection of electric cables.

### EXAMPLES

Different polymeric solutions were prepared and their stability was evaluated.

The polymers used are as follows:
Polyurethane (PU): Desmoderm® KB2H, available from Bayer,
Polyethersulfone (PES): PES® E3010, available from BASF,
Polysulfone PSU: Solvay Udel® P-3500.

The following solvent compositions were prepared:
DMSO=100%,
2-pyrrolidone=100%,
DMSO/2-pyrrolidone=50/50 ratio by weight, obtained by mixing 45 g of DMSO and 45 g of 2-pyrrolidone,
DMSO/2-pyrrolidone=20/80 ratio by weight, obtained by mixing 18 g of DMSO and 72 g of 2-pyrrolidone,

The polymeric solutions were subsequently prepared by addition of the polymer to each solvent composition. They exhibit the following proportions:
PU solution=12.5% by weight of PU and 87.5% by weight of the solvent composition, obtained by adding 12.86 g of PU and 90 g of solvent composition,
PES solution=15% by weight of PES and 85% by weight of the solvent composition, obtained by adding 15.88 g of PES and 90 g of solvent composition,
PSU solution=10% by weight of PSU and 90% by weight of the solvent composition, obtained by adding 10 g of PSU and 90 g of solvent composition.

The PES and PU polymer solutions are stirred and heated on a water bath at 50° C. until completely dissolved. The stability at 0° C. is subsequently observed for 1 day.

The PSU solutions are stirred and heated on a water bath at 70° C. until completely dissolved. The stability at low temperature (0° C.) is subsequently observed for 3 weeks.

The results are presented in the tables below.

TABLE 1
Evaluation of the solubility at 50° C., dissolution time
and appearance after returning to ambient temperature
(25° C.) of the polyethersulfone solutions
PES

| | | | Appearance |
|---|---|---|---|
| Solvent | Solubility at | Dissolution | after returning |
| composition | 50° C. | time | to ambient temperature |
| DMSO | Yes - | 5 h | Transparent, very slightly |
| | transparent | | yellow, liquid |
| | orangey liquid | | |
| 2-Pyrrolidone | Yes - | 24 h | Transparent yellow liquid |
| | transparent | | |
| | yellow liquid | | |
| DMSO/2- | Yes - | 8 h | Transparent yellow liquid |
| pyrrolidone | transparent | | |
| 50/50 | yellow liquid | | |

TABLE 2
Evaluation of the stability of the polyethersulfone solutions at low
temperature (0° C.) after storing for 1 day
PES

| | Stability at low temperature |
|---|---|
| Solvent composition | (0° C.) after storing for 1 day |
| DMSO | Solid |
| 2-Pyrrolidone | Solid |
| DMSO/2-pyrrolidone 50/50 | Fluid |

The solvent composition according to the invention makes it possible to improve the stability at low temperature of polymeric solutions comprising a polyethersulfone while maintaining a satisfactory appearance after returning to ambient temperature.

TABLE 3
Evaluation of the solubility at 50° C., dissolution time and
appearance after returning to ambient temperature (25° C.)
of the polyurethane solutions
PU

| | | | Appearance |
|---|---|---|---|
| Solvent | Solubility at | Dissolution | after returning |
| composition | 50° C. | time | to ambient temperature |
| DMSO | Yes - | 7 h | Transparent yellow fluid |
| | transparent | | |
| | yellow liquid | | |
| 2-Pyrrolidone | Yes - | 10 h | Transparent colorless |
| | transparent | | viscous |
| | colorless liquid | | |
| DMSO/2- | Yes - | 12 h | Transparent colorless |
| pyrrolidone | transparent | | fluid |
| 50/50 | colorless liquid | | |

TABLE 4
Evaluation of the stability of the polyurethane solutions at low
temperature (0° C.) after storing for 1 day
PU

| Solvent | Stability at low temperature |
|---|---|
| composition | (0° C.) after storing for 1 day |
| DMSO | Solid |
| 2-Pyrrolidone | Solid |
| DMSO/2- | Viscous liquid |
| pyrrolidone 50/50 | |

The solvent composition according to the invention makes it possible to improve the stability at low temperature of polymeric solutions comprising a polyurethane and to obtain an improved appearance after returning to ambient temperature.

TABLE 5
Evaluation of the solubility at 50° C., dissolution time and
appearance after returning to ambient temperature (25° C.)
of the polysulfone solutions
PSU

| Solvent | Solubility at | Dissolution | Appearance after returning |
|---|---|---|---|
| composition | 50° C. | time | to ambient temperature |
| DMSO | Yes - cloudy | 10 h | White gel at the bottom, |
| | white liquid | | colorless supernatant liquid |
| 2- | Yes - | 20 h | Transparent colorless liquid |
| Pyrrolidone | transparent | | |
| | colorless liquid | | |
| DMSO/2- | Yes - | 15 h 20 | Transparent colorless liquid |
| pyrrolidone | transparent | | |
| 50/50 | colorless liquid | | |
| DMSO/2- | Yes - | 18 h 30 | Transparent colorless liquid |
| pyrrolidone | transparent | | |
| 20/80 | colorless liquid | | |

TABLE 6
Evaluation of the stability of the polysulfone solutions at low temperature
(0° C.) after storing for 1, 2 and 3 weeks
PSU

| Solvent | Stability at low temperature (0° C.) | | |
|---|---|---|---|
| composition | 1 week | 2 weeks | 3 weeks |
| DMSO | Solid | Solid | Solid |
| 2-Pyrrolidone | Solid at the end of 1 | Solid | Solid |
| | hour | | |
| DMSO/2- | Transparent | Transparent | Transparent |
| pyrrolidone | colorless fluid | colorless fluid | colorless fluid |
| 50/50 | | | |
| DMSO/2- | Solid at the end of 4 | Solid | Solid |
| pyrrolidone | hours | | |
| 20/80 | | | |

Table 6 shows that the polysulfone solution according to the invention is more stable than a solution of polysulfone in DMSO alone or in 2-pyrrolidone alone.

In particular, the polysulfone solutions comprising a solvent composition comprising DMSO and 2-pyrrolidone in a 50/50 ratio give excellent results in terms of stability at low temperature, this being the case over a period of time ranging up to 3 weeks.

1. A solvent composition comprising a mixture of at least one molecule having at least one sulfoxide functional group and of at least one molecule having at least one amide functional group where the nitrogen atom carries a hydrogen atom (—NH—C(O)—), wherein said solvent composition comprises less than 1% by weight of polyethersulfones.

2. The solvent composition according to claim 1, wherein the molecule having the amide functional group is cyclic.

3. The solvent composition according to claim 1, wherein the molecule having a sulfoxide functional group is dimethyl sulfoxide.

4. The solvent composition according to claim 1, wherein the molecule having an amide functional group is 2-pyrrolidone.

5. The solvent composition according to claim 1, comprising dimethyl sulfoxide and 2-pyrrolidone.

6. The solvent composition according to claim 1, comprising:
from 21% to 75% by weight of the molecule having a sulfoxide functional group,
from 25% to 80% by weight of the molecule carrying an amide functional group where the nitrogen atom carries a hydrogen atom,
with respect to the total weight of the solvent composition.

7. A method for improving the stability of solutions of polymers comprising sulfone or urethane functional groups, wherein the method comprises a step of combining the solvent composition according to claim 1 with polymer comprising sulfone functional groups or urethane functional groups.

8. The method according to claim 7, wherein the polymer comprises polysulfone or polyethersulfone or polyphenylsulfone.

9. A polymer solution, said polymer solution comprising a solvent composition comprising a mixture of at least one molecule having at least one sulfoxide functional group and of at least one molecule having at least one amide functional group where the nitrogen atom carries a hydrogen atom (—NH—C(O)—), said polymer solution comprising less than 1% by weight of polyethersulfones.

10. The polymer solution according to claim 9, wherein the polymer comprises sulfone or urethane functional groups.

11. The polymer solution according to claim 9 wherein the solvent composition comprises a mixture of at least one molecule having at least one sulfoxide functional group and of at least one molecule which is cyclic and which has at least one amide functional group where the nitrogen atom carries a hydrogen atom (—NH—C(O)—).

12. The polymer solution according to claim 9, comprising:
from 5% to 50% by weight of polymers, and
from 50% to 95% by weight of the solvent composition,
with respect to the total weight of the polymer solution.

13. A filtration membrane obtained from the polymer solution according to claim 9.

14. An artificial leather obtained from the polymer solution according to claim 9.

15. A method of manufacturing an article selected from the group consisting of films, artificial leather, polymeric suede, polymeric fibers, coatings, membranes, batteries, and electronic circuits, or for protecting electric cables, wherein the method comprises a step of dissolving a polymer in a solvent composition according to claim 1.
